(19) United States
(12) Patent Application Publication
(10) Pub. No.: US 2008/0292118 A1
(43) Pub. Date: Nov. 27, 2008

(54) Bone-Conduction Device and Method of Manufacturing the Same

(76) Inventor: Mikio Fukuda, Tokyo (JP)

Correspondence Address: SCHMEISER, OLSEN & WATTS, 22 CENTURY HILL DRIVE, SUITE 302, LATHAM, NY, 12110, US

(21) Appl. No.: 10/595,639

(22) PCT Filed: Sep. 2, 2005
(86) PCT No.: PCT/JP05/01913

§ 371 Date: May 2, 2006

(30) Foreign Application Priority Data
Feb. 13, 2004 (JP) 2004-037229
Mar. 31, 2004 (JP) 2004-106702

(51) Int. Cl. H04R 1/00

(52) U.S. Cl. 381/151

(57) ABSTRACT

The object is to provide a bone-conduction speaker and its manufacturing method, wherein: efficiency in production is excellent due to reduction in man-hours needed to produce the speaker's parts; any cumbersome removal operation of grinding dust is eliminated; and, variations in product's lowest resonance frequency derived from variations in diaphragm's thickness are minimized, which contributes to improvement in stability of the product's quality and in reliability of the product. The speaker comprises: a yoke (1) having a center magnetic pole and a voice coil wrapped around the pole; magnets (2) disposed on opposite extensions of the yoke (1); diaphragm fixing portions (3) disposed on the other opposite extensions of the yoke (1); the diaphragm (4) fixed to the fixing portions (3); and a plate yoke (6) fixed to the diaphragm (4) to which the yoke (6) has its outer peripheral edges adjacent to the fixing portions (3) laser-welded.

### TECHNICAL FIELD

The present invention relates to a bone-conduction device and a method of manufacturing the bone-conduction device, and more particularly to a bone-conduction device and a method of manufacturing the bone-conduction device, which comprises a bone-conduction speaker and a bone-conduction microphone each compact in construction and manufactured in an easy manner.

### BACKGROUND ART

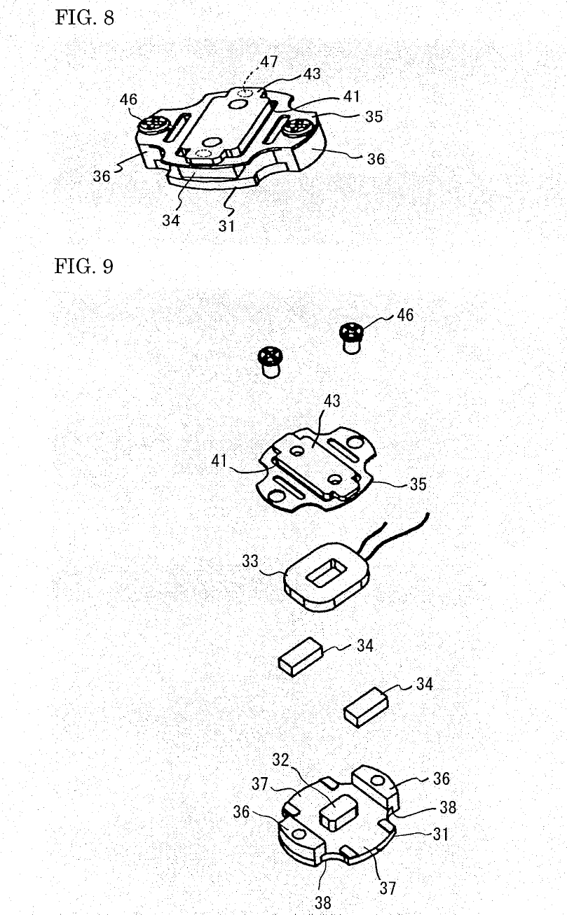

One of bone-conduction speakers known in the art is shown in FIGS. 8-10 (see Japanese Patent No, 2967777). This one comprises a voice coil 33 wrapped around a center magnetic pole 32, which forms a portion of a yoke 31. The yoke 31 is provided with 4 pieces of extensions 37, 38 each extending outward from the yoke 31 in each of four different directions. Of these four extensions, each of opposite extensions 37, 37 is provided with a magnet 34 disposed thereon. On the other hand, the other opposite extensions 38, 38 are provided with diaphragm fixing portions 36, 36 each of which forms an upright portion of the extension 38. Fixedly mounted on each of the diaphragm fixing portions 36, 36 by means of setscrews 46 is a diaphragm 35 or vibrating plate, which is provided with a center opening 41. A yoke plate 43 fixedly mounted on the diaphragm 35 is supported inside the center opening 41 of the diaphragm 35 in a manner such that the yoke plate 43 is permitted to vibrate inside this center opening 41.

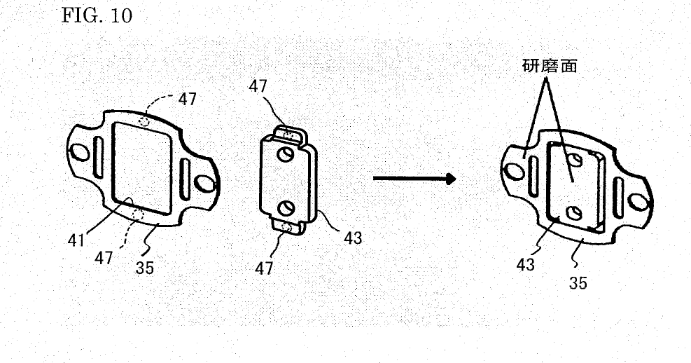

In the bone-conduction speaker having the above construction, in order to insure that the bone-conduction speaker is sufficient in mechanical strength and enjoys stability in power output, the diaphragm 35 and the plate yoke 43 are spot-welded together at their two contact points 47, 47 one of which is an upper contact point 47 and the other a lower contact point 47 (see FIGS. 8 and 10). In this spot-welding case, the diaphragm 35 and the plate yoke 43 thus spot-welded together are subjected to grinding operations after completion of the welding operation so as to remove any distortion or shoulder portion appearing in the surfaces of both the diaphragm 35 and the plate yoke 43 which are warped, deformed or reduced in thickness by a large amount of welding heat (see grinding surfaces shown in FIG. 10)

In such a conventional bone-conduction speaker and the method of manufacturing the same described above, the number of man-hours needed to produce the parts of the conventional bone-conduction speaker is too large. This considerably impairs the conventional speaker in productivity. In addition, it is cumbersome for the user to be forced to check the spot-welded portions in mechanical strength by the application of load to the welded portions (by pushing) since it is impossible for the user to check such concealed welded portions through visual inspection.

Furthermore, since the grinding operations are performed after completion of the welding operation of the diaphragm 35, it is hard for the user to control the extent of the grinding operations. Consequently, variations in thickness of the part, particularly of the diaphragm 35 after completion of its grinding operations, have a tendency to increase since the grinding operations are performed after completion of the welding operations of the diaphragm 35. As a result, variations occur in lowest resonance frequency of each product since the lowest resonance frequency of each product mainly depends on the thickness of the diaphragm 35. Due to this, the conventional bone-conduction speaker is poor in stability of the product's quality and reliability. Further, as for removal of the grinding dust or waste produced during the grinding operations, it is difficult to completely remove such dust or waste. In other words, it takes too much time. This is one of problems inherent in the conventional bone-conduction device.

In addition, as for an output of a magnetic type acoustic transducer, that is a device for converting acoustic energy to electrical or mechanical energy, such as the speaker or microphone of this type, the output depends on a narrow gap formed between the yoke and the diaphragm (or the plate yoke). Due to this, it is necessary to determine such narrow gap within a predetermined range in assembly. However, heretofore there is no proposal on a method for determining the narrow gap in assembly in an easy manner without fail.

Patent document 1: Japanese Patent No. 2967777.

### DISCLOSURE OF THE INVENTION

### Problems to be Solved by the Invention

Since the conventional bone-conduction device and the method of manufacturing the device suffer from many problems described above, it is an object of the present invention to provide a bone-conduction device and a method of manufacturing the bone-conduction device, which are free from such many problems and capable of contributing to improvements in stability of the product's quality and reliability by: reducing the number of the man-hours needed to produce the parts of the device to improve the device in productivity; eliminating the cumbersome removal operations of the grinding dust or waste; and, preventing occurrence of variations in lowest resonance frequency of each product as completely as possible, which variations in the lowest resonance frequency are caused by variations in thickness of the diaphragm.

It is another object of the present invention to provide a bone-conduction device and a method of manufacturing the bone-conduction device, which are capable of determining the narrow gap formed between the yoke and the diaphragm (or the yoke plate) in assembly within a predetermined range of value in an easy manner without fail.

### Means for Solving the Problems

In the present invention, the above problems are solved by providing a bone-conduction device characterized by comprising: a yoke, which carries a voice coil and a magnet; and, a diaphragm disposed on the yoke through a narrow gap formed therebetween; wherein the diaphragm is provided with a center opening in which a plate yoke is disposed, and the plate yoke is provided with a diaphragm abutting portion which abuts against the diaphragm, wherein the diaphragm abutting portion has its outer end edge laser-welded to the diaphragm.

In the present invention, the above problems is solved also by providing a bone-conduction device characterized by comprising: a yoke, which carries a voice coil and a magnet; and, a diaphragm disposed on the yoke through a narrow gap formed therebetween; wherein the diaphragm has its opposite ends bent to form bent portions, wherein the bent portion is fixedly mounted on an outer side surface of a diaphragm fixing wall of the yoke.

Further, in order to solve the above problem, in a method of manufacturing a bone-conduction device comprising: a yoke, which carries a voice coil and a magnet; and, a diaphragm disposed on the yoke through a narrow gap formed therebetween, the improvement comprises the step of laser-welding an outer end edge of a diaphragm abutting portion of a plate yoke to the diaphragm, wherein the diaphragm is provided with a center opening, and the plate yoke is disposed in the center opening of the diaphragm.

In a method of manufacturing a bone-conduction device comprising: a yoke, which carries a voice coil and a magnet; and, a diaphragm disposed on the yoke through a narrow gap formed therebetween, the improvement which comprises the steps of: bending opposite ends of the diaphragm to form bent portions, and, fixing the bent portion to an outer side surface of a diaphragm fixing wall of the yoke.

The method of manufacturing a bone-conduction device as set forth in claim 7 or 8, wherein: prior to fixing the bent portion of the diaphragm, a spacer is sandwiched between the diaphragm and the yoke, wherein the spacer has a thickness equal to that of the gap and is pulled out of the gap after completing of a fixing operation of the bent portion of the diaphragm to the outer side surface of the diaphragm fixing wall.

### EFFECT OF THE INVENTION

According to the present invention, the bone-conduction device and the method of manufacturing the device contribute to the stability of product's quality and the reliability of the product, because: it is possible for the present invention to reduce the number of man-hours needed to produce the parts of the device, which improves the device and the method in productivity; any grinding operation is not required in the present invention, so that a cumbersome removal operation of the grinding dust or waste is not required at all in the present invention; and, variations in lowest resonance frequency of the product, which are caused by variations in thickness of the diaphragm, are substantially prevented from occurring, which leads to the improvement in stability of product's quality and the reliability of the product.

In the case where the diaphragm has its outer end edge or its opposite bent portions laser-welded to the diaphragm fixing portion, any screw set portion is not required. This makes it possible to save a space for the installation of such screw set portions, and therefore makes it possible to downsize the device as a whole. This is one of effects of the present invention.

In the present invention as set forth in the appended claims 7 to 9, it is possible to set the gap between the diaphragm and the yoke in an easy manner without fail.

This is one of effects inherent in the present invention.

### BEST MODE FOR CARRYING OUT THE INVENTION

Preferred embodiments for carrying out the present invention will be described with reference to the accompanying drawings. Incidentally, there is substantially no difference in construction between a bone-conduction speaker and a bone-conduction microphone except that: in the former, a vibrating plate or diaphragm issues its output or bone-conduction vibrations; whereas, in the latter, the vibrating plate or diaphragm picks up the bone-conduction vibrations. Due to this, it should be understood that a bone-conduction device, which will be described in the following description, comprises both the bone-conduction speaker and the bone-conduction microphone.

There is substantially no difference in essential construction between the bone-conduction device of the present invention and the conventional bone-conduction device. In other words, the essential construction is constructed of: a yoke 1 provided with a center pole and a voice coil wrapped around the center pole, the yoke extending outward in four different directions; magnets 2 disposed on two extensions of the yoke 1, which extensions extend in the two different directions of the four different directions; diaphragm fixing portions 3 each disposed on each of the other two extensions of the yoke 1; and, a vibrating plate or diaphragm 4 fixedly mounted on the diaphragm fixing portions 3.

In construction, the bone-conduction device of this type is of a so-called “outer magnet type”. However, it is also possible for the bone-conduction device to be of a so-called “inner magnet type”.

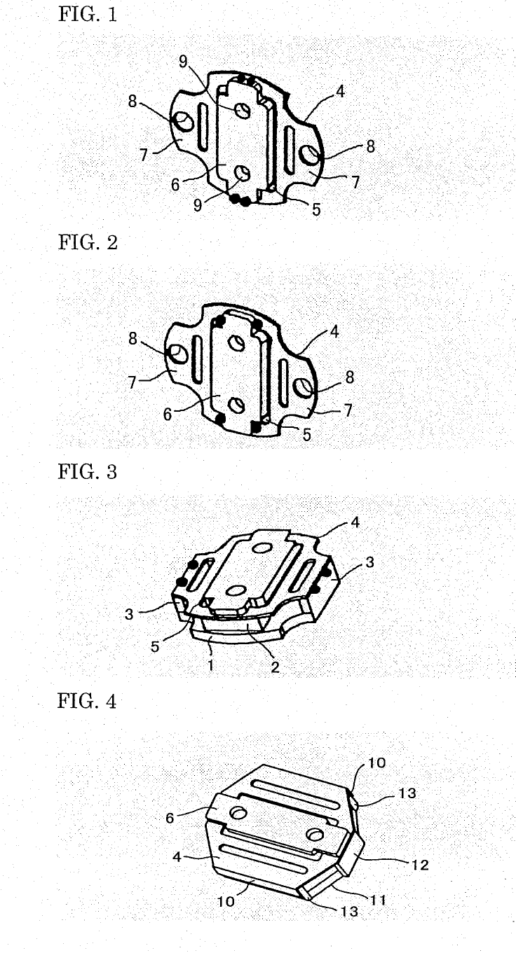

As shown in FIGS. 1 to 3, the diaphragm 4 assumes a shape provided with four extensions extending outward in four different directions. As is clear from the drawings, the diaphragm 4 is further provided with a center opening 5. Mounted adjacent to the center opening 5 of the diaphragm 4 on this diaphragm 4 is a plate yoke 6. The plate yoke 6 extends along the center opening 5 and has its portion faced the center opening 5, wherein the thus faced portion is increased in thickness to form a thick portion. on the other hand, the plate yoke 6 has its opposite end portions disposed adjacent to the diaphragm 4, wherein such opposite end portions is decreased in thickness to form opposite thin end portions. Further, the plate yoke 6 is provided with a tapped hole 9 for fixing the plate yoke 6 in an appropriate manner.

The plate yoke 6 is fixedly mounted on the diaphragm 4 by having edges of its opposite-end diaphragm abutting portions 7 laser-welded to the diaphragm 4. Such laser welding may be performed at a single spot on each of the diaphragm abutting portions 7. Preferably, the number of the welded spots is equal to two or more than two in order to insure the strength and stability of the welded portions (shown by black spots in the drawings). Such welded portions may be formed in a front end of each of the diaphragm abutting portions 7 (see FIG. 1). It is also possible to form the welded portions in each of opposite side end portions of the plate yoke 6 (see FIG. 2).

The laser welding is a method for joining two metals by applying heat to the metals to melt and fuse them using a heat source or concentrated light beam with an intensified energy density and by solidifying the thus welded portions of the metals so as to loin the metals. Consequently, such laser welding is free from any deformation of metals, for example such as a reduction in thickness of the metals or plates having been welded in a conventional welding method. Due to this, in case of the laser welding, there is not required any grinding operation for removing a shoulder portion appearing in the welded portions of the metals. This makes it possible to reduce the number of man-hours needed to produce the parts of the bone-conduction device.

The diaphragm 4 shown in FIGS. 1 and 2 is provided with a screw set portion 7 as is in the case of the conventional bone-conduction speaker. Each of the screw set portions 7 of the diaphragm 4 is larger in size than an upper and a lower extension for mounting the magnets thereon (as viewed in FIGS. 1 and 2). In FIGS. 1 and 2, the screw set portions 7 extends to the right and the left of the diaphragm 4. Formed in each of the screw set portions 7 is a through-hole, which forms a screw hole 8. A set screw (not shown) is threadably connected with each of the diaphragm fixing portions 3 through the screw hole 8 and tightened, so that the diaphragm 4 is fixedly mounted on the diaphragm fixing portions 3.

On the other hand, there is no provision of the screw set portion 7 in the diaphragm 4 shown in FIG. 3. As a result, each of the diaphragm fixing portions 3 of the diaphragm 4 shown in FIG. 3 is smaller in size than that of the diaphragm 4 shown in FIGS. 1 and 2. In this case of the diaphragm 4 shown in FIG. 3, the diaphragm 4 has each of its opposite side edge portions laser-welded to each of the corresponding opposite side edge portions formed in the diaphragm fixing portions 3. Also in this case, in order to insure the strength and stability of the welded portions (each denoted by a black spot in FIG. 3), the number of the welded portions is preferably equal to two or more than two. By using this welding method, it is possible to save a space needed to provide each of the screw holes 8 in the diaphragm 4. This may contribute to the compaction of the bone-conduction speaker as a whole in construction.

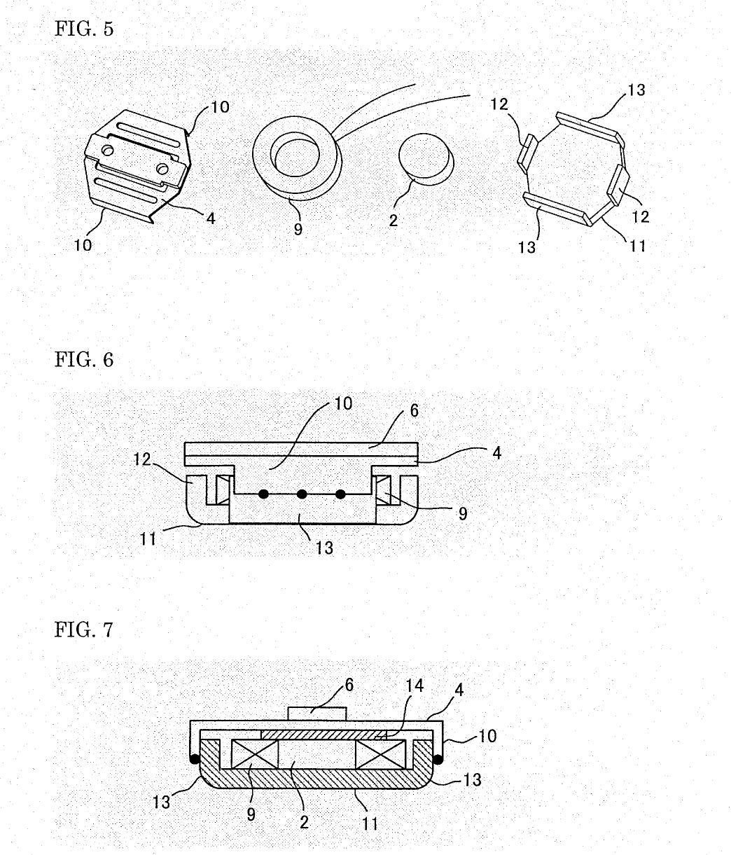

The bone-conduction device shown in FIGS. 4 and 5 is of the inner magnet type in which: the magnet 2 is disposed inside the voice coil 9; the diaphragm 4 has its opposite end portions bent to form a pair of bent portions 10, 10; and, these bent portions 10, 10 are fixedly mounted on opposite diaphragm fixing walls 13, 13, wherein these walls 13, 13 form opposite upright portions of a yoke base 11 and are spaced apart from an outer yoke 12. These bent portions 10, 10 are fixedly mounted on outer surfaces of the diaphragm fixing walls 13, 13 through a joining process such as a welding, a bonding or like processes. Of these joining processes, a preferable one is a laser-welding process (see the black spots shown in FIG. 6).

In case of this process, prior to fixedly mounting the bent portion 10 on the outer surface of the diaphragm fixing wall 13, a tape-like spacer 14 is sandwiched between the diaphragm 4 and the outer yoke 12 in a manner such that the spacer 14 has its end portion extended outward (see FIG. 7). As is clear from FIG. 7, the spacer 14 has a thickness equal to a predetermined gap formed between the diaphragm 4 and the outer yoke 12. By means of this spacer 14 thus sandwiched, it is possible to keep the gap at a predetermined value. Consequently, in this state, the bent portion 10 is fixedly mounted on the outer surface of the diaphragm fixing wall 13. After completion of this mounting operation, the spacer 14 is pulled out of the gap so that the gap is kept at a predetermined value.

While the present invention has been described in detail to some extent with reference to the preferred embodiments thereof, it will be understood by those skilled in the art that various changes in form and details may be made therein without departing from the spirit and scope of the present invention as defined by the appended claims. In other words, the present invention is not limited in scope by its specified embodiments.

### BRIEF DESCRIPTION OF THE DRAWINGS

[FIG. 1] is a view illustrating a method for fixedly mounting the plate yoke to the diaphragm, which plate yoke forms the bone-conduction device of the present invention.

[FIG. 2] is a view illustrating another method for fixedly mounting the plate yoke on the diaphragm, which plate yoke forms the bone-conduction device of the present invention.

[FIG. 3] is a view illustrating a method for fixing the yoke and the diaphragm, which constitute the bone-conduction device of the present invention.

[FIG. 4] is a perspective view illustrating another construction of the bone-conduction device of the present invention.

[FIG. 5] is an exploded perspective view of the bone-conduction device shown in FIG. 4.

[FIG. 6] is a side view of the bone-conduction device shown in FIG. 4.

[FIG. 7] is a longitudinal sectional view illustrating the method of manufacturing the bone-conduction device shown in FIG. 4.

[FIG. 8] is a view illustrating the conventional bone-conduction speaker.

[FIG. 9] is an exploded perspective view of the conventional bone-conduction speaker.

[FIG. 10] is a view illustrating the method for fixing the yoke and the diaphragm, which constitute the conventional bone-conduction speaker.

1. A bone-conduction device characterized by comprising: a yoke, which carries a voice coil and a magnet; and, a diaphragm disposed on said yoke through a narrow gap formed therebetween; wherein said diaphragm is provided with a center opening in which a plate yoke is disposed, and said plate yoke is provided with a diaphragm abutting portion which abuts against said diaphragm, wherein said diaphragm abutting portion has its outer end edge laser-welded to said diaphragm.

2. The bone-conduction device as set forth in claim 1, wherein said diaphragm has its outer end edge laser-welded to a diaphragm fixing portion of said yoke.

3. A bone-conduction device characterized by comprising: a yoke, which carries a voice coil and a magnet; and, a diaphragm disposed on said yoke through a narrow gap formed therebetween; wherein said diaphragm has its opposite ends bent to form bent portions, wherein said bent portion is fixedly mounted on an outer side surface of a diaphragm fixing wall of said yoke.

4. The bone-conduction device as set forth in claim 3, wherein said bent portion of said diaphragm is laser-welded to said outer side surface of said diaphragm fixing wall.

5. In a method of manufacturing a bone-conduction device comprising: a yoke, which carries a voice coil and a magnet; and, a diaphragm disposed on said yoke through a narrow gap formed therebetween, the improvement which comprises the step of laser-welding an outer end edge of a diaphragm abutting portion of a plate yoke to said diaphragm, wherein said diaphragm is provided with a center opening, and said plate yoke is disposed in said center opening of said diaphragm.

6. The method of manufacturing the bone-conduction device as set forth in claim 5, wherein said diaphragm has its outer end edge laser-welded to said diaphragm fixing portion.

7. In a method of manufacturing a bone-conduction device comprising: a yoke, which carries a voice coil and a magnet; and, a diaphragm disposed on said yoke through a narrow gap formed therebetween, the improvement which comprises the steps of: bending opposite ends of said diaphragm to form bent portions; and, fixing said bent portion to an outer side surface of a diaphragm fixing wall of said yoke.

8. The method of manufacturing a bone-conduction device as set forth in claim 7, wherein said bent portion of said diaphragm is laser-welded to said outer side surface of said diaphragm fixing wall.

9. The method of manufacturing a bone-conduction device as set forth in claim 7, wherein: prior to fixing said bent portion of said diaphragm, a spacer is sandwiched between said diaphragm and said yoke, wherein said spacer has a thickness equal to that of said gap and is pulled out of said gap after completing of a fixing operation of said bent portion of said diaphragm to said outer side surface of said diaphragm fixing wall.

10. The method of manufacturing a bone-conduction device as set forth in claim 8, wherein: prior to fixing said bent portion of said diaphragm, a spacer is sandwiched between said diaphragm and said yoke, wherein said spacer has a thickness equal to that of said gap and is pulled out of said gap after completing of a fixing operation of said bent portion of said diaphragm to said outer side surface of said diaphragm fixing wall.
